(19) United States
(12) Patent Application Publication
(10) Pub. No.: US 2004/0246265 A1
(43) Pub. Date: Dec. 9, 2004

(54) Four-color display

(76) Inventor: Gary K. Starkweather, Bellevue, WA (US)

Correspondence Address: Steven J Rocci, Woodcock Washburn LLP, One Liberty Place 46th floor, Philadelphia, PA, 19103, US

(21) Appl. No.: 10/455,827

(22) Filed: Jun. 6, 2003

(51) Int. Cl. G09G 5/02

(52) U.S. Cl. 345/589

(57) ABSTRACT

A color display (i.e., multicolor computer display) employs four additive primary colors, namely, red, green, and blue and an additional cyan-based color referred to as “supercyan.” The primary color supercyan corresponds to light with a wavelength of about 500 nm and functions to extend the color gamut of a color display significantly beyond the green-blue axis of conventional color displays.

### TECHNICAL FIELD

The present invention relates to correlating the color gamuts of computer displays and computer printers and, in particular, to extending the color gamut of computer displays to encompass the color gamuts of computer printers to a greater extent.

### BACKGROUND AND SUMMARY

Multi-color computer displays (referred to herein as “color displays”) commonly generate a range of colors, sometimes called a color gamut, from three primary colors: red, green, and blue. Color displays may employ any of a variety of display technologies including liquid crystal displays, cathode-ray tubes, digital micromirror devices, projection. displays, etc. The color gamut of a color display results from different proportions of the red, green, and blue primary colors being combined together and the spectral purity of the primary colors. The proportional amounts of the red, green, and blue primaries are cumulative, so color displays are referred to as using additive primary colors. Full amounts of the red, green, and blue primary colors would combine together generally to form white or an approximation of it.

FIG. 1 shows a two-dimensional color gamut graph 10 representing the 1931 CIE color diagram of the color gamut available to, or discernible by, human vision. Color gamut graph 10 is a simplified representation of a three-dimensional color space, as is known in the art. Within color gamut graph 10 is plotted a color display graph 12 representing the color gamut of a hypothetical color display.

The color gamut of color display graph 12 is defined by the color points 14, 16, and 18, which correspond to the maximum intensities of respective red, green, and blue primary colors of light available from the hypothetical color display. The proportionally small region of color gamut graph 10 encompassed by color display graph 12 illustrates that color displays are capable of rendering only a limited portion of discernible colors.

Multi-color computer printers (referred to herein as “color printers”) also generate a range of colors, or a color gamut, from three primary colors. However, the primary colors used by color printers are cyan, magenta, and yellow, not the red, green, and blue of color displays. The color gamut of a color printer results from different proportions of the cyan, magenta, and yellow primary colors being combined together. The proportional amounts of the cyan, magenta, and yellow primary colors are subtractive relative to each other. Full amounts of the cyan, magenta, and yellow primary colors would combine together generally to form black or an approximation of it. Some color printers further include a separate black ink, rather than printing black from a combination of cyan, magenta, and yellow.

Within color gamut graph 10 is plotted a color printer graph 22 representing the color gamut of a hypothetical color printer. The color gamut of color display graph 22 is defined by the color points 24, 26, and 28, which correspond to the maximum cyan, magenta, and yellow intensities, respectively, available from the hypothetical color printer.

Graphs 12 and 22 share an overlapping region 30 (indicated by cross-hatching), which represents colors that are within the capabilities of both the color display and the color printer. Much work has been done to provide accurate mappings between color display and color printer points within overlapping region 30. Non-overlapping color gamut regions, particularly the large cyan color printer region 32 extending beyond the green-blue axis of color display graph 12, have commonly been deemed unavailable in computer displays.

With respect to cyan color printer region 32, for example, the consequence is that a user cannot discern from viewing a color display the full extent of color available from a color printer. In most design applications, users work primarily from color displays, but generate finished designs on color printers. The complete unavailability of a significant portion of a printer color gamut (e.g., cyan color printer region 32) means that users cannot efficiently utilize that portion in design applications.

Accordingly, the present invention includes color displays (i.e., multicolor computer displays) that employ four additive primary colors, namely, red, green, and blue and an additional cyan-based color referred to as “supercyan.” The primary color supercyan corresponds to light with a wavelength of about 500 nm and functions to extend the color gamut of a color display significantly beyond the green-blue axis of conventional color displays. As a result, a color display employing the four primary colors of the present invention can encompass the full range of cyans available to color printers. In one implementation, an active matrix liquid crystal display (AMLCD) includes a matrix of red, green, and blue and supercyan color filters to provide the four primary colors.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is a color gamut graph representing a conventional hypothetical color computer display and a hypothetical color computer printer.

FIG. 2 is a color gamut graph representing a hypothetical color computer display according to the present invention.

FIG. 3 is a schematic diagram illustrating a color filter arrangement for implementing a pixelated four-color display.

FIG. 4 a schematic diagram illustrating a conventional prior art three-color filter arrangement.

### DETAILED DESCRIPTION OF PREFERRED EMBODIMENTS

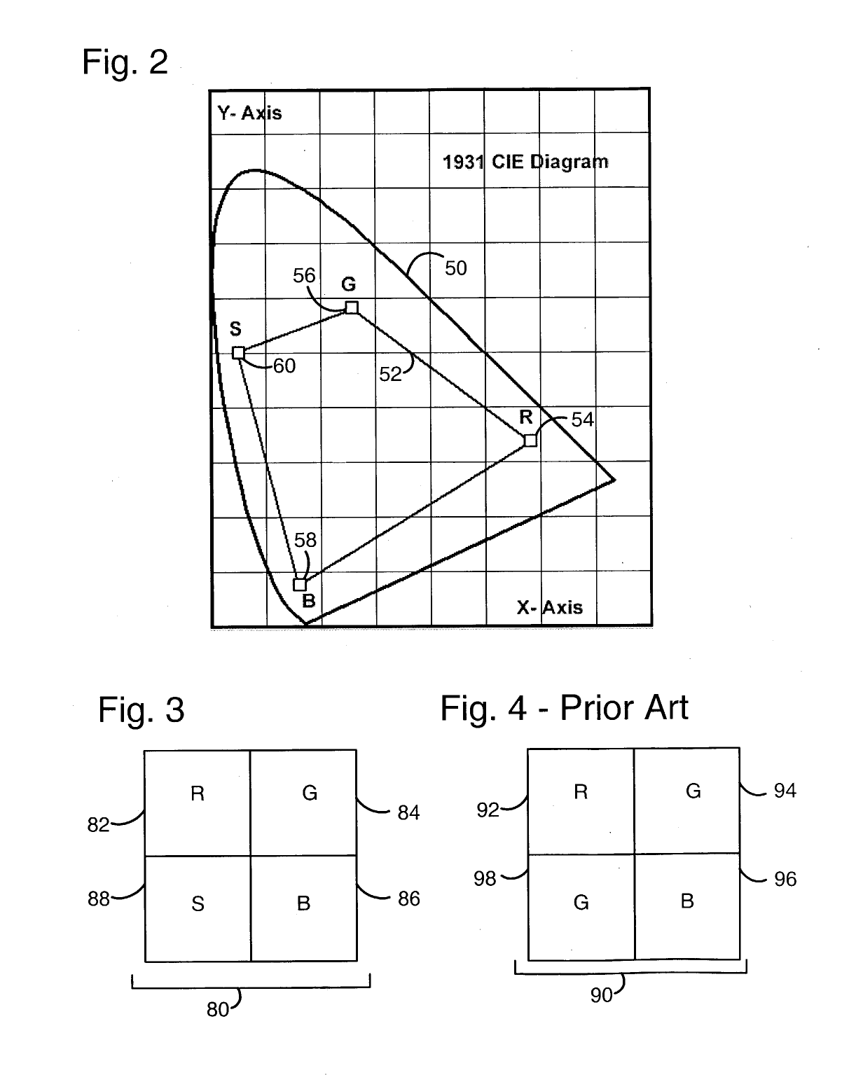

FIG. 2 shows a two-dimensional color gamut graph 50 representing the 1931 CIE color diagram of the color gamut available to, or discernible by, human vision. Within color gamut graph 50 is plotted a color display graph 52 representing the color gamut of a hypothetical four-color multi-color computer display (referred to herein as a “color display”) according to the present invention. The four-color display may employ any of a variety of display technologies including liquid crystal displays, cathode-ray tubes, digital micromirror devices, projection displays, etc.

The color gamut of color display graph 52 is defined by the color points 54, 56, 58, and 60, which correspond to the maximum light intensities of respective the colors red, green, blue, and a cyan-based color called “supercyan” available from the hypothetical four-color display. The primary color supercyan corresponds to light with a wavelength of about 500 nm (nanometers), with a 30 nm spectral width.

FIG. 3 is a schematic diagram illustrating color filter arrangement 80 for implementing a pixelated four-color display, as in a liquid crystal display (LCD) panel. One example of such a display panel suited to implementation of color filter arrangement 80 would be an active matrix LCD panel.

Color filter arrangement 80 includes red, green, blue, and supercyan sub-pixel color filters 82, 84, 86, and 88, respectively. Each set of sub-pixel color filters 82, 84, 86, and 88 corresponds to a single pixel in a pixelated display, such as an active matrix LCD. As is common, a pixelated display typically includes an N×M array of pixels.

Accordingly, a pixelated four-color display according to the present invention would include an N×M array of color filter arrangements 80, one color filter arrangement 80 for each pixel in the display.

FIG. 4 is a schematic diagram illustrating a conventional prior art three-color filter arrangement 90 as used in pixelated three-color displays. Color filter arrangement 90 includes red, green, blue, and green sub-pixel color filters 92, 94, 96, and 98, respectively. Each set of sub-pixel color filters 92, 94, 96, and 98 corresponds to a single pixel in a pixelated display, such as an active matrix LCD.

FIGS. 3 and 4 illustrate that the pattern of color filters in a four-color display, as illustrated in FIG. 3, can be the same as that of a conventional three-color display. The difference between the two is the selection of a supercyan color filter 88 in a four-color display in place of a green color filter (e.g., filter 98) in a three-color display. Maintaining the patterning used in three-color displays allows display panels with four-color displays to be manufactured with the same tooling and equipment as is used for three-color displays. In this example, screen luminance might be reduced with the four-color display in relation to a three-color display because cyan is not as visible as green. The differences are expected to be small and acceptable.

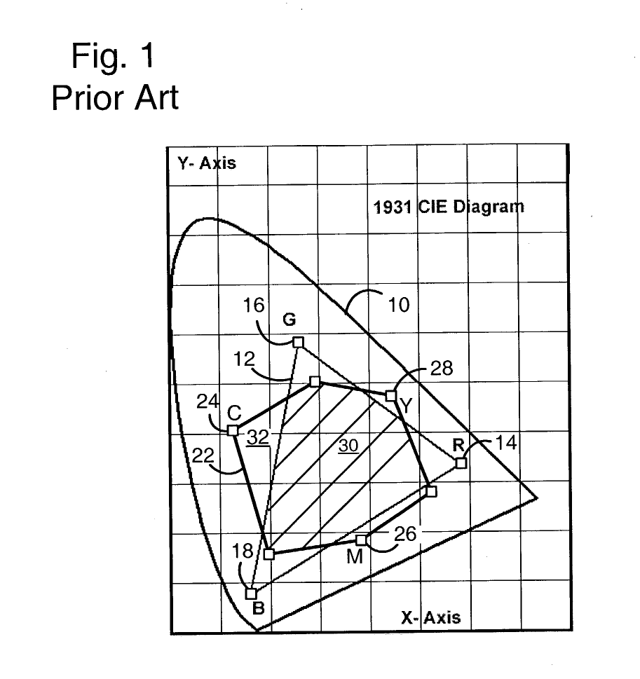

The color gamut of a four-color display, as represented by color display graph 52 (FIG. 2), provides the ability to represent the color gamut of a color printer to a much greater extent than conventional three-color displays. In particular, the color gamut of a four-color display can encompass the significant cyan color printer region 32 (FIG. 1) that is outside the color gamut of conventional three-color displays. It is believed that including the cyan color printer region 32 (FIG. 1) in a color display would remove a serious impediment to correlating the color gamuts of color displays and color printers. The four-color display allows images on screen to represent a wider range of images on paper.

It will be appreciated that four-color displays according to the present invention may be implemented in any color display technology that can accommodate the supercyan primary color. An active matrix LCD is such a display in that color filters are reasonably selectable for specific wavelengths and spectral widths. Various other types of displays also employ selectable color filters, such as many field-sequential LCDS, displays employing color wheel filters (e.g., digital micromirror devices), etc. As is known in the art, field-sequential color displays successively filter light of different colors corresponding to a common set of pixels. Other display technologies, such as CRTs, may also be able to implement four-color displays. However, the selectablility of CRT phosphor colors is typically much more restrictive than the selectability of colors for color filters.

Having described and illustrated the principles of our invention with reference to an illustrated embodiment, it will be recognized that the illustrated embodiment can be modified in arrangement and detail without departing from such principles. In view of the many possible embodiments to which the principles of our invention may be applied, it should be recognized that the detailed embodiments are illustrative only and should not be taken as limiting the scope of our invention. Rather, I claim as my invention all such embodiments as may come within the scope and spirit of the following claims and equivalents thereto.

1. A multi-color computer display, comprising:
four primary colors from which a color gamut is displayed, the four primary colors including red, green, blue, and a cyan-based primary color.

2. The display of claim 1 in which the four primary colors are formed by four corresponding color filters associated with the display.

3. The display of claim 2 comprising an array of plural pixels and in which the four-color filters are formed as an arrangement sub-pixel color filters for each pixel in the array.

4. The display of claim 2 comprising an array of plural pixels and in which the four-color filters provide field-sequential color filtering in which the filters successively filter light corresponding to a common set of pixels.

5. The display of claim 2 in which the cyan-based primary color includes a wavelength of about 500 nanometers.

6. The display of claim 5 in which the cyan-based primary color is centered on a wavelength of about 500 nanometers and includes a spectral width of about 30 nanometers.

7. A multi-color computer display, comprising:
four primary colors from which a color gamut is displayed, the four primary colors including red, green, blue, and a cyan-based primary color including a wavelength of about 500 nanometers.

8. The display of claim 7 in which the four primary colors are formed by four corresponding color filters associated with the display.

9. The display of claim 8 comprising an array of plural pixels and in which the four-color filters are formed as an arrangement sub-pixel color filters for each pixel in the array.

10. The display of claim 8 comprising an array of plural pixels and in which the four-color filters provide field-sequential color filtering in which the filters successively filter light corresponding to a common set of pixels.

11. The display of claim 7 in which the cyan-based primary color is centered on a wavelength of about 500 nanometers and includes a spectral width of about 30 nanometers.

12. A multi-color computer display, comprising:
a color gamut with four points that define four vertices in a color space, one of the four points corresponding to a cyan-based primary color.

13. The display of claim 12 in which the cyan-based primary color includes a wavelength of about 500 nm.

14. The display of claim 13 in which the cyan-based primary color has a spectral width of about 30 nm.
